(19) United States
(12) Patent Application Publication
(10) Pub. No.: US 2007/0169062 A1
(43) Pub. Date: Jul. 19, 2007

(54) Suspending memory analyzing of a program performed by a runtime memory analysis system

(75) Inventor: Jasper Kamperman, Sunnyvale, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Intel Corporation

(21) Appl. No.: 11/314,145

(22) Filed: Dec. 20, 2005

(51) Int. Cl. G06F 9/44

(52) U.S. Cl. 717/162

(57) ABSTRACT

A precondition function is specified in native code. The function includes a condition to be met before a target library function is executed. A memory analysis suspends its memory analysis function based on the specified precondition function.

### BACKGROUND

1. Field

The present invention relates generally to computer programming and more particularly to the use of a runtime memory analysis system.

2. Background

Debugging is one of the most important phases in the life of software development. It is a crucial step to ensure a robust software product.

One of the goals of debugging is to detect improper use of memory. Memory leaks and corruptions are common concerns among application developers because these problems lead to application crashes and performance degradation. Conventionally, for every application program developed, the developer maintains two versions, namely a production and a debug version. Each version is compiled separately where the debug version is often significantly larger in size because it contains a large amount of debug information such as “assertions” for checking anomalous conditions and error logging. When a problem arises while an application is run, the developer runs the corresponding debug version and tries to recreate the problem. Once the problem is recreated, the error log is studied for hints relating to the issue and the location of the code in an effort to resolve the programming error. The debug version, however, does not maintain metadata about the state of memory used by the application program. Further, maintaining two versions of an application program and all the libraries used by the application program is cumbersome and time consuming.

Recently, instead of maintaining two versions for each application program, application developers utilize third party software products such as Valgrind™ to provide memory monitoring services. These products monitor the memory usage and detect memory corruptions at runtime while an application program is running. With the help of these runtime memory analysis systems, application developers no longer need to maintain two different versions of a single application program. However, once an application program is run under the environment of these runtime memory analysis systems, the developers have little control as to the extent of monitoring and analyzing that an application program should receive.

Programming methodology encourages the concept of reusability. Application developers use libraries to avoid rewriting the same functions. Both static libraries and dynamically loaded libraries (DLLs or shared objects) have been used to encapsulate these reusable functions. For example, it is common for an application developer to call a function in a math library that finds the roots of polynomials, where the math library is compiled as a separate entity.

The runtime memory analysis system not only monitors the memory usage of an application program, it also monitors the memory used by the library function calls made from the application program. Often, these libraries are provided by third parties and are tested before they are made available to the application developers.

As an alternative to the memory analysis and monitoring products mentioned above, application developers can choose to write an application program in a “managed language” such as JAVA, VB.Net, C#, or J#. The term managed language refers to programming languages that are interpreted and executed typically by a virtual machine program, also referred to in this case as the runtime environment. The managed language has a predefined mechanism for exchanging information between the application program and the runtime environment. The mechanism specifies that at any point during execution of an application program, the runtime environment may stop the program and retrieve information specific to the current programming instruction. The information that is accessible generally pertains to runtime state, such as processor register or stack memory contents. This gives the developer the ability to manage and monitor her program's memory usage. In contrast, native code, such as C, C++, and Fortran, provide no such inherent management capability.

Although containing inherent memory usage checking capability, managed languages do have limitations. The predetermined checking embedded in the language is relatively fixed and extensive in scope. This requires extra processing time and power and therefore sacrifices the performance of an application program. In addition, the developers do not have a choice as to the extent their code should be monitored. Also, it requires the native code developers to learn a new programming language or convert their existing native code to the managed code. Existing managed languages provide only limited and generic condition checking, that is, a developer is limited to basic checking mechanisms, for example, an array bounds checking, that are predetermined by the managed language author. If the developer develops a function using customized data structures, the generic condition checking will not provide the full extent of checking required to cover the domain of the function.

### BRIEF DESCRIPTION OF THE DRAWINGS

Various embodiments are illustrated by way of example and not by way of limitation in the figures of the accompanying drawings in which like references indicate similar elements. It should be noted that references to “an,” “one,” or “various” embodiments in this disclosure are not necessarily to the same embodiment, and such references mean at least one.

FIG. 1 is a generalized overview of operations in accordance with an embodiment of the invention.

FIG. 2 is a detailed overview of a library specification and its relationship with neighboring components in accordance with an embodiment of the invention.

FIG. 3 is a flow chart illustrating how a library specification may be used in accordance with an embodiment of the invention.

FIG. 4 is a flow chart illustrating a process in which a library specification may be specified.

FIG. 5 is an overview of example computer hardware on which a software system, in accordance with an embodiment of the invention, may be run.

### DETAILED DESCRIPTION

A method for specifying a library specification with precondition and postcondition functions relating to a runtime memory analysis system that analyzes a program is described below. The program may be written in an “unmanaged language”, i.e. one that does not have inherent memory monitoring capability to help in debugging. A person of ordinary skill in the pertinent art, upon reading the present disclosure, will recognize that various novel aspects and features of the present invention can implemented independently or in any suitable combination, and further, that the disclosed embodiments are merely illustrative and not meant to be limiting.

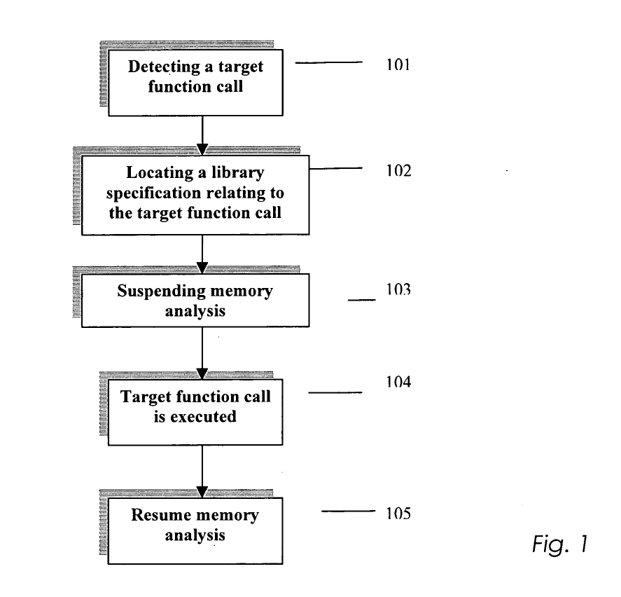

FIG. 1 depicts a generalized overview of operations in accordance with an embodiment of the invention. In operation 101, a runtime memory analysis system detects a target function call. If a target function call is detected, then before the target function is executed, the runtime memory analysis system locates a library specification relating to the target function call (operation 102). If the library specification is located, the memory analyzing or checking that is normally performed by the runtime memory analysis system is suspended (operation 103) before executing the target function (operation 104). Subsequent to executing the target function, the runtime memory analysis system resumes its memory analyzing function (operation 105). In one embodiment of the invention, the duration that a runtime memory analysis system suspends its operation may be in relation to the time it requires to execute the target function in completion.

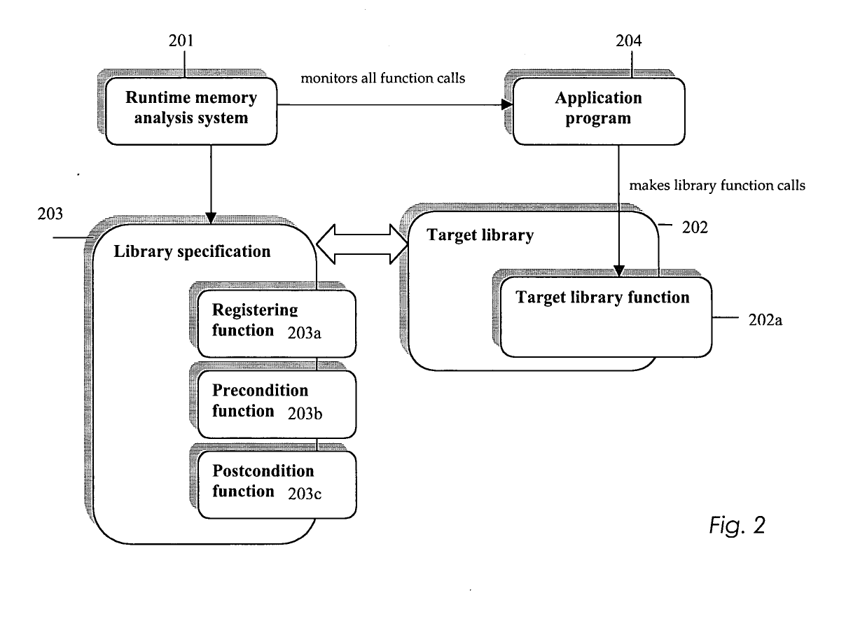

FIG. 2 shows a detailed overview depicting the relationship between a library specification and its neighboring components in accordance with an embodiment of the invention. A runtime memory analysis system 201 monitors the memory usage for each function called by an application program 204 and all the target library functions 202a used by the application program. For example, an application program appMatrixMult may be written to multiply two matrices, a and b (not shown). Initially, the application program makes several function calls that request and accept n numbers from a user and form two matrices, a and b, where n is an arbitrary finite number. Subsequently, the application program calls a matrix function, e.g. matrix_mult(a, b, c), encapsulated in a target library 202, that multiplies matrix a and matrix b and obtains the product, matrix c. If the runtime memory analysis system monitors appMatrixMult for its memory usage in accordance with its normal or default mode of operation, it will not only monitor the n function calls from the application that request and accept n numbers from a user, it will also monitor the matrix_mult(a, b, c) function from the target library.

In one embodiment of the invention, for every target library, there is a corresponding library specification 203. For example, if matrix_mult( ) is encapsulated in a target library called matrix.lib, a corresponding library specification may be called matrix.lib.sp to demonstrate the correspondence. The correspondence between the target library and the library specification can be implemented in a number of ways as long as the corresponding library specification can be identified based on the target library. In one embodiment, the name of the library specification is derived from the name of the target library.

In one embodiment of the invention, a library specification 203 may encapsulate a precondition function 203b and a postcondition function 203c. The precondition function 203b may contain at least one function that checks for specific memory usage by the target library. The checking may be referred to as a condition. For example, the precondition function may include several memory management subroutines preferably maintained by the runtime memory analysis system such as check_initialize(matrix* a) and check_initialize(matrix* b) where a and b are matrices and the routines check whether matrix a and matrix b are initialized. The precondition function in this example may be called pre_matrix_mult( ). When a precondition function is executed, the memory management subroutines, included in the precondition function, may also be executed. If the precondition function returns a passing value, the target library function 202a is executed without having the runtime memory analysis system 201 monitoring the memory usage of the target function 202a. In one embodiment of the invention, these memory management subroutines are accessible via a runtime application programming interface (API).

In one embodiment of the invention, the routines from the library specification use functions provided by the runtime memory analysis system to query the metadata maintained by the runtime memory analysis system. For example, meta_check_initialized_byte(void *p) returns a Boolean value indicating whether or not the byte pointed at by p is initialized according to the runtime memory analysis system.

In one embodiment of the invention, if the precondition function does not return passing values, the runtime memory analysis system may continue to analyze the memory usage while the target library function, e.g. matrix_mult( ), is executed.

The postcondition function 203c encapsulated in the library specification may be executed after returning from the target library function call. In one embodiment of the invention, the postcondition function may include function calls that update the memory state used by the target library function. The function call that updates the memory state may be referred to as a condition.

The library specification contains at least one registering function 203a that registers with the runtime memory analysis system 201 the association between the target library 202 and the precondition function 203b, and the association between the target library 202 and the postcondition function 203c. In one embodiment of the invention, the association may be based on the address of the precondition function 203b, the postcondition function 203c, and the target library 202. In another embodiment of the invention, the name of the registering function may be derived from the name of the target library.

An advantage of an embodiment of the invention may be appreciated from the following example. A library developer develops a “large” target library function, where having the runtime memory analysis system monitors the memory usage by the target library function call at runtime not only requires extensive processing time and power, the monitoring can also degrade the program's performance. Instead, the developer may wish to customize the memory checking and instruct the runtime memory analysis system to monitor her library function in a specify way. One embodiment of the invention gives the library developer a tool to specify, in the library specification, the extent to which a certain library function may be monitored. For example, while a runtime memory analysis system monitors the application program and its target library function call, if the runtime memory analysis system encounters a target library that has its corresponding library specification, the runtime memory analysis system, instead of monitoring the memory usage of the target function call according to its build-in monitoring routines, the runtime memory analysis system suspends its monitoring function and follows the instructions specified in the library specification. The suspension of the runtime memory analysis system may improve program performance and save processing time and power without scarificing the debugging requirement.

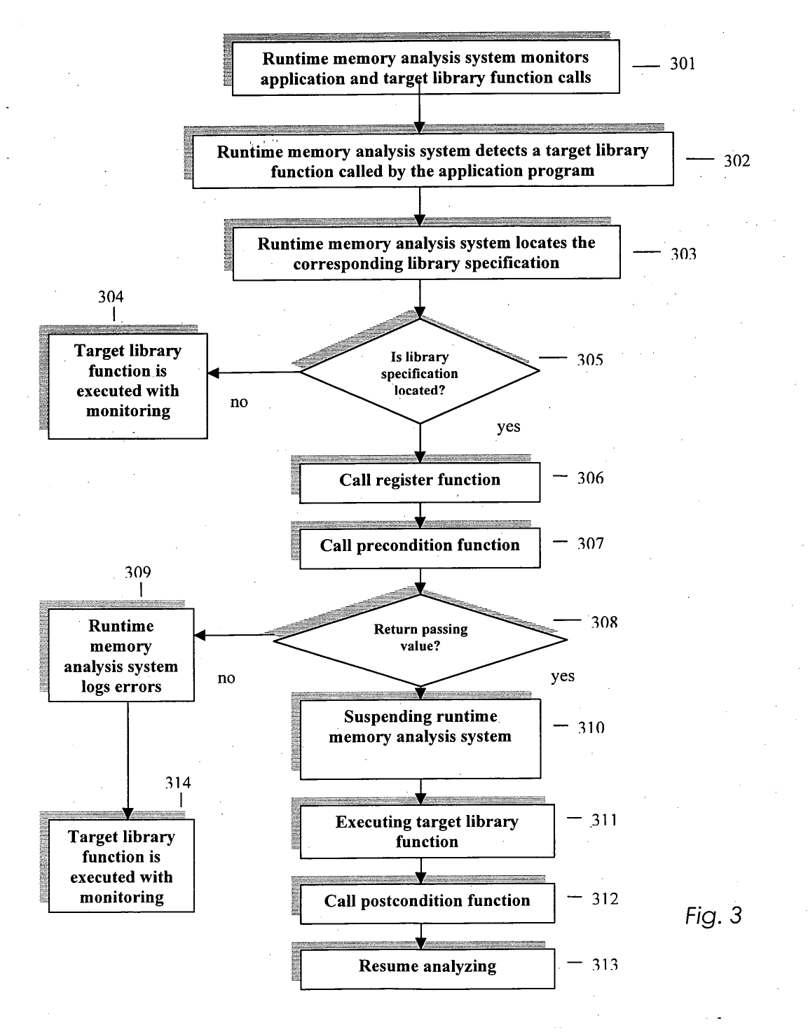

FIG. 3 is a detailed flow chart illustrating one of the embodiments of the invention. A runtime memory analysis system monitors application and target library function calls in operation 301. The application program calls its own application functions and loads at least one target library. In operation 302, the runtime memory analysis system detects a target library function called by the application program. In operation 303, the runtime memory analysis system locates a corresponding library specification for each target library loaded. The runtime memory analysis system determines whether a corresponding library specification is located in operation 305. If a corresponding library specification is not located, the target library function is executed and the runtime memory analysis system may not suspend its monitoring function and continues to monitor the memory usage by the target function call (operation 304).

If, however, a corresponding library specification is found, the runtime memory analysis system loads the library specification and the registering function is executed in operation 306 to register the association between the target library and the precondition function, and the association between the target library and the postcondition function. Before the target library function is executed, the runtime memory analysis system calls the precondition function in operation 307 and checks the return value of the precondition function call in operation 308. If no passing value is returned, the runtime memory analysis system logs error in operation 309, and the target library function is executed while the runtime memory analysis continues to monitor the memory usage by the target library function (operation 314). If, however, the precondition function returns a passing value, the runtime memory analysis system suspends its analyzing function in operation 310. The target function may be executed in operation 311. After returning from the execution of the target library function, the postcondition function is executed to update the memory state used by the target library function in operation 312. After the postcondition function is called, the runtime memory analysis system continues its monitoring function of the memory usage by other function calls in operation 313.

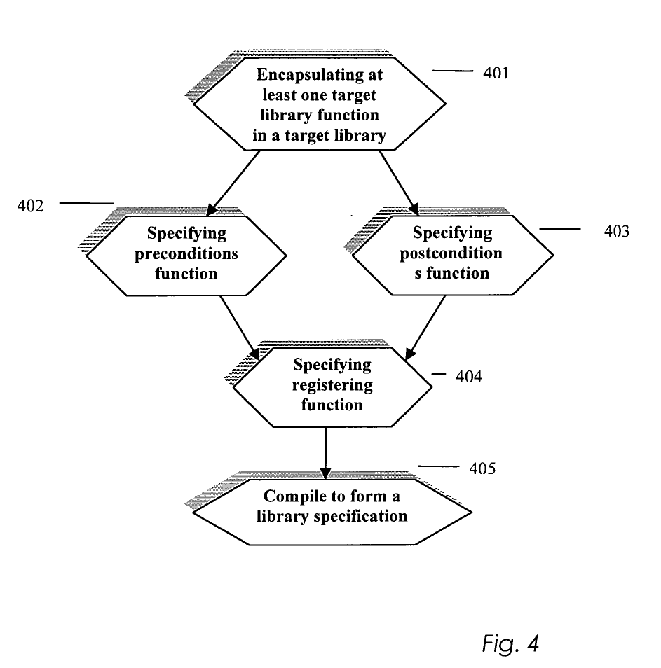

FIG. 4 is a flow chart illustrating the process is which a library specification may be specified. In one embodiment of the invention, a target library may encapsulate at least one target library function in operation 401. For example, matrix.lib is the target library that encapsulates a target library function, matrix_mult( ). For every target library, at least one precondition function in operation 402 or at least one postcondition function in operation 403 are specified. Subsequently, a registering function in operation 404 associates the target library with the precondition function in operation 402, and with the postcondition function in operation 403.

In one embodiment of the invention, a registering function is executed to register the precondition function by associating the target library function to the precondition function, based on the address of the target library function and the address of the precondition function. In addition, the registering function is also executed to register postcondition function, by associating the target library function to the postcondition function, based on the address of the target library function and the address of the postcondition function.

A registering function may be implemented in a number of ways. In one embodiment of the invention, a registering function may be two separate registering functions where one registers with the runtime memory analysis system the association between the precondition function and the target library function and one registers the association between the postcondition function and the target library function. In another embodiment of the invention, only one registering function may be used to register both the association between the precondition function and the target library function and the association between the postcondition function and the target library function.

After the registering function in operation 404 is specified, a combination of functions including the registering function specified in operation 404, the precondition function specified in operation 402, and the postcondition function specified in operation 403, are compiled to formulate the library specification in operation 405. In one embodiment of the invention, the runtime memory analysis system may maintain a database structure recording each of the registered function and the various functions encapsulated within.

In one embodiment of the invention, the library specification may correspond to the target library in that the library specification contains at least a precondition function and a postcondition function wherein the precondition function includes at least one condition to be met before the target library is executed and wherein a postcondition function includes at least one update to be made after returning from the execution of the target library.

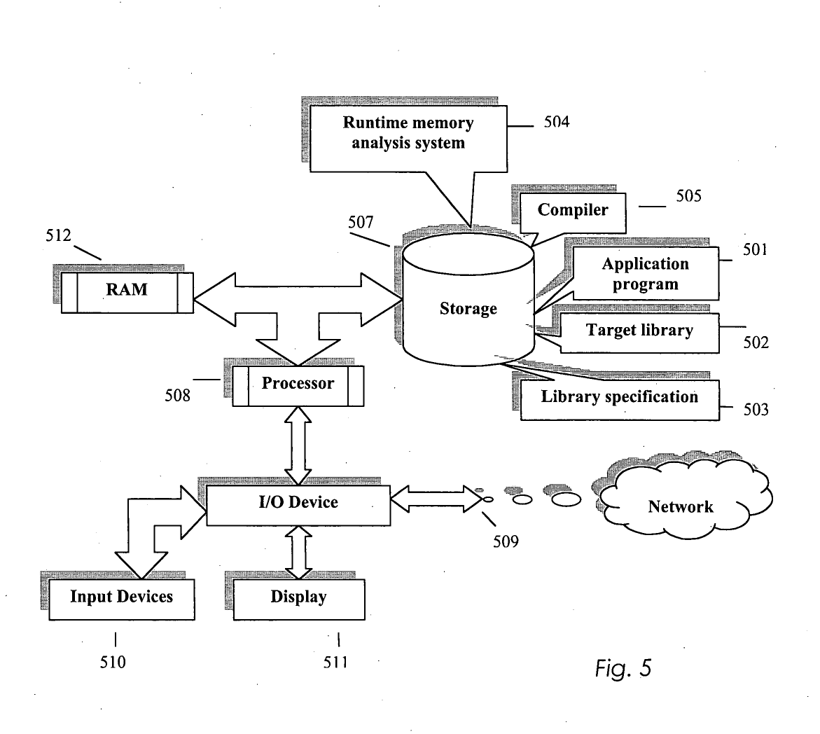

FIG. 5 is an overview of example computer hardware on which a software system in accordance with an embodiment of the invention may be run. An application program 501, a target library 502, a library specification 503, a runtime memory analysis system 504, and compiler 505 can reside as software stored in a storage media 507 (e.g. a magnetic disk, CD-ROM, optical disk) which is machine readable. This configuration is merely shown as example and is not to limit the different ways in which the hardware and software may be implemented. Not all the software components listed above need to reside in a single storage media. For example, the compiler 505 and the source files of the application program 501 and the library specification 503 do not need to be accessible to the processor at runtime. A developer may compile the application program 501, the target library 502, and the library specification 503 using compiler 505 on a different machine where the machine executing the application program 501 may need only the runtime analysis system 504, the target library 502, and the library specification 503 to be present. The processor 508 is merely provided as an example and not to limit the system to a single processor environment. These components may reside in several storage media as long as they are accessible by the processor 508. The processor 508 can also mean multiple processors on multiple machines. Furthermore, not all the components need to be physically in a single machine. For example, the application program 501 and the target library 502 can be stored in storage media 507, not shown in the figure, but accessible across the network 509.

In one embodiment of the invention, a library developer may specify the target library functions 202a, and compile them using the compiler 505, into a target library 502. The library developer may then specify precondition function 203b, postcondition function 203c, and registering function 203a, and compile these functions using the compiler 505, into the library specification 503. The library developer may provide the specification through input devices 501, such as a keyboard, a mouse, or a pointing device. The library developer may view the result of the compilation via display 511.

When application program 501 is launched, at least a portion of the machine readable code, often referred to as the binary code, is loaded into the random access memory (RAM) 512 for accessing and execution by the processor 508. The loading of the binary code includes the loading of the code from the target library 502 used by the application program 501. The runtime memory analysis system 504 monitors and analyzes the memory usage of the application program including the target library function called by the application program. When the runtime memory analysis system detects a loading of a target library, it attempts to locate a corresponding library specification. If the library specification is located, it is loaded from the storage media 507 into the RAM 512 as well.

Once the library specification is loaded, the runtime memory analysis system calls the registering function, not shown in the figure, to register the association between the precondition function, the postcondition function, and the target library function. In one embodiment of the invention, the association may be made between the precondition function, the postcondition function, and the target library where the precondition function is written in a generic way to deal with all the functions in the target library.

Subsequent to the execution of the registering function, the precondition function is called to check on memory that may be used by the target library function. If the precondition function returns a passing value, the runtime memory analysis system suspends its analysis function. The target library function is then executed without memory analysis performed by the runtime memory analysis system. Subsequent to the execution of the target library function, the postcondition function is executed to update the state of memory used by the target library function. Thereafter, the runtime memory analysis system resumes its analysis function for the remaining application program and its target library function calls.

A machine-readable medium may include any mechanism for storing or transmitting information in a form readable by a machine (e.g., a computer), not limited to Compact Disc Read-Only Memory (CD-ROMs), Read-Only Memory (ROMs), Random Access Memory (RAM), Erasable Programmable Read-Only Memory (EPROM), and a transmission over the Internet.

Although the invention has been described in detail hereinabove, it should be appreciated that many variations and/or modifications and/or alternative embodiments of the basic inventive concepts taught herein that may appear to those skilled in the pertinent art will still fall within the spirit and scope of the present invention as defined in the appended claims.

We claim:

1. A method comprising:
specifying a precondition function, in native code, wherein the precondition function includes a condition to be met before a target library function is executed; and
suspending memory analysis performed by a runtime memory analysis system based on the specified precondition function.

2. The method of claim 1 further comprising:
specifying a postcondition function, in native code, wherein the postcondition function includes a condition to be held upon returning from the execution of the target library function.

3. The method of claim 1, wherein the condition further comprising:
a set of memory management subroutines, wherein the subroutines relates to checking the memory usage of the target library function.

4. The method of claim 2, wherein the condition further comprising:
a set of memory management subroutines, wherein the subroutines relates to updating the memory state maintained by the runtime memory analysis system.

5. The method of claim 2 further comprising:
specifying a registering function, in native code, to register within the runtime memory analysis system, the association between the precondition function, postcondition function and the target library function.

6. The method of claim 5, wherein the registering function registers the precondition function by associating the target library function to the precondition function, based on the address of the target library function and the address of the precondition function and by associating the target library function to the postcondition function, based the address of the target library function and the address of the postcondition function.

7. The method of claim 5, wherein the name of the registering function is derived from the name of the target library.

8. The method of claim 5 further comprising:
producing a library specification based on the registering function, wherein the specification is executed upon detecting a target library function to be used by an application program.

9. The method of claim 8, wherein the name of the library specification is derived from the name of the target library.

10. The method of claim 9, wherein the set of predetermined subroutines are accessible via a runtime application programming interface (API).

11. A computer implemented method comprising:
locating a library specification, wherein the library specification includes a precondition function and a postcondition function; and
if the library specification is located, executing the library specification, by a runtime memory analysis system and:
(a) executing the precondition function;
(b) executing a target library function, while suspending the memory analysis of the target library function; and
(c) executing the postcondition function, subsequent to the execution of the target library function.

12. The method of claim 11, wherein the precondition function includes a condition to be met before the target library function is executed and the postcondition function includes a condition to be held upon returning from the execution of the target library function.

13. The method of claim 11, the locating of the library specification is triggered by a loading of the target library.

14. The method of claim 11, the precondition and postcondition functions are related to memory management subroutines, wherein the subroutines are a set of predetermined subroutines maintained by the runtime memory analysis system.

15. The method of claim 11, wherein executing the precondition function causes a checking of the memory usage of the target library function.

16. The method of claim 11, wherein executing the postcondition function causes an update of the memory state maintained by the runtime memory analysis system.

17. A computer implemented system comprising;
an application program;
a target library, wherein the target library includes a target library function to be used by the application program;
a library specification includes a registering function that registers a precondition function and a postcondition function associated to the target library function; and
a runtime memory analysis system to locate the library specification when the target library is used by an application program, to call the registering function, and upon each target library function call, to execute the precondition function, to suspend the analyzing of the memory usage, to execute the target library function, and to execute the postcondition function.

18. The system of claim 17, wherein the precondition function includes a condition to be met before the target library function is executed and wherein the postcondition function includes a condition to be held upon returning from the execution of the target library function.

19. The system of claim 17, the precondition and postcondition functions are related to memory management subroutines, wherein the subroutines are a set of predetermined subroutines maintained by the runtime memory analysis system.

20. The system of claim 19, wherein the set of predetermined subroutines are accessible via a runtime application programming interface (API).

21. The system of claim 17, wherein the registering function registers the precondition function based on the address of the target library function and the address of the precondition function, and function registers the postcondition function based the address of the target library function and the address of the postcondition function.

22. The system of claim 17, wherein the precondition function relates to checking the memory usage of the target library function.

23. The system of claim 17, wherein the postcondition function relates to updating the memory state maintained by the runtime memory analysis system.

24. A machine-accessible medium that provides instructions that, when executed by a processor, causes the processor to perform operations comprising:
detecting the loading of a target library function;
locating a library specification, in response to the detected target library function;
if the library specification is located, executing the library specification, by a runtime memory analysis system and:
(a) executing a registering function to register within a runtime memory system, the association between the precondition function, postcondition function and the target library function;
(b) executing a precondition function, wherein the precondition function includes a condition to be met before the target library function is executed;
(c) executing the target library function, while suspending the memory analysis of the target library function; and
(d) executing a postcondition function, wherein the postcondition function includes a condition to be held upon returning from the execution of the target library function.

25. The machine accessible medium of claim 24, wherein the precondition and postcondition functions relate to memory management subroutines, wherein the subroutines are a set of predetermined subroutines maintained by the runtime memory analysis system.

26. The machine accessible medium of claim 24, wherein the precondition function relates to checking the memory usage of the target library function.

27. The machine accessible medium of claim 24, wherein the postcondition function relates to updating the memory status maintained by the runtime memory analysis system.
